(19) United States
(12) Patent Application Publication
(10) Pub. No.: US 2013/0031114 A1
(43) Pub. Date: Jan. 31, 2013

(54) INFORMATION PROCESSING APPARATUS, INFORMATION PROCESSING METHOD, AND COMPUTER READABLE MEDIUM

(71) Applicant: Saneyuki KOBAYASHI, Kanagawa (JP)

(72) Inventor: Saneyuki KOBAYASHI, Kanagawa (JP)

(73) Assignee: FUJI XEROX Co., Ltd., Tokyo (JP)

(21) Appl. No.: 13/367,961

(22) Filed: Feb. 7, 2012

(30) Foreign Application Priority Data
Jul. 27, 2011 (JP) 2011-164019

(51) Int. Cl. G06F 17/30

(52) U.S. Cl. 707/755; 707/E17.012

(57) ABSTRACT

An information processing apparatus includes a first selection unit that selects at least one first element in tree-structured data, a second selection unit that selects a second element corresponding to the first element selected by the first selection unit, and an extracting unit that extracts tree-structured data representing a subtree defined by the first element selected by the first selection unit and the second element selected by the second selection unit in order to copy the tree-structured data into different tree-structured data.

### CROSS-REFERENCE TO RELATED APPLICATIONS

This application is based on and claims priority under 35 USC 119 from Japanese Patent Application No. 2011-164019 filed Jul. 27, 2011.

### BACKGROUND

### Technical Field

The present invention relates to an information processing apparatus, an information processing method, and a computer readable medium.

### SUMMARY

According to an aspect of the invention, there is provided an information processing apparatus including a first selection unit that selects at least one first element in tree-structured data, a second selection unit that selects a second element corresponding to the first element selected by the first selection unit, and an extracting unit that extracts tree-structured data representing a subtree defined by the first element selected by the first selection unit and the second element selected by the second selection unit in order to copy the tree-structured data into different tree-structured data.

### BRIEF DESCRIPTION OF THE DRAWINGS

An exemplary embodiment of the present invention will be described in detail based on the following figures, wherein:

FIG. 1 is a schematic module configuration diagram according to an exemplary embodiment of the invention;

FIG. 2 is a module configuration diagram illustrating an exemplary configuration according to the exemplary embodiment;

FIG. 3 is a flowchart of an example of a process according to the exemplary embodiment;

FIG. 4 is a flowchart of an example of a process according to the exemplary embodiment;

FIG. 5 illustrates an example of a structured document;

FIG. 6 illustrates an example of displayed tree structure of the structured document;

FIG. 7 illustrates an example of a start point element and an end point element selected in the tree structure of a structured document;

FIG. 8 illustrates an example of a user interface for selecting the end point;

FIG. 9 illustrates an example of a start point element and an end point element selected in the tree structure of a structured document;

FIG. 10 illustrates an example of a user interface for selecting the end point;

FIG. 11 illustrates an example of a start point element and an end point element selected in the tree structure of a structured document;

FIG. 12 illustrates an example of a user interface for selecting the end point;

FIG. 13 illustrates a displayed structured document including elements having the same name; and

FIG. 14 is a block diagram illustrating an exemplary hardware configuration of a computer for realizing the exemplary embodiment.

### DETAILED DESCRIPTION

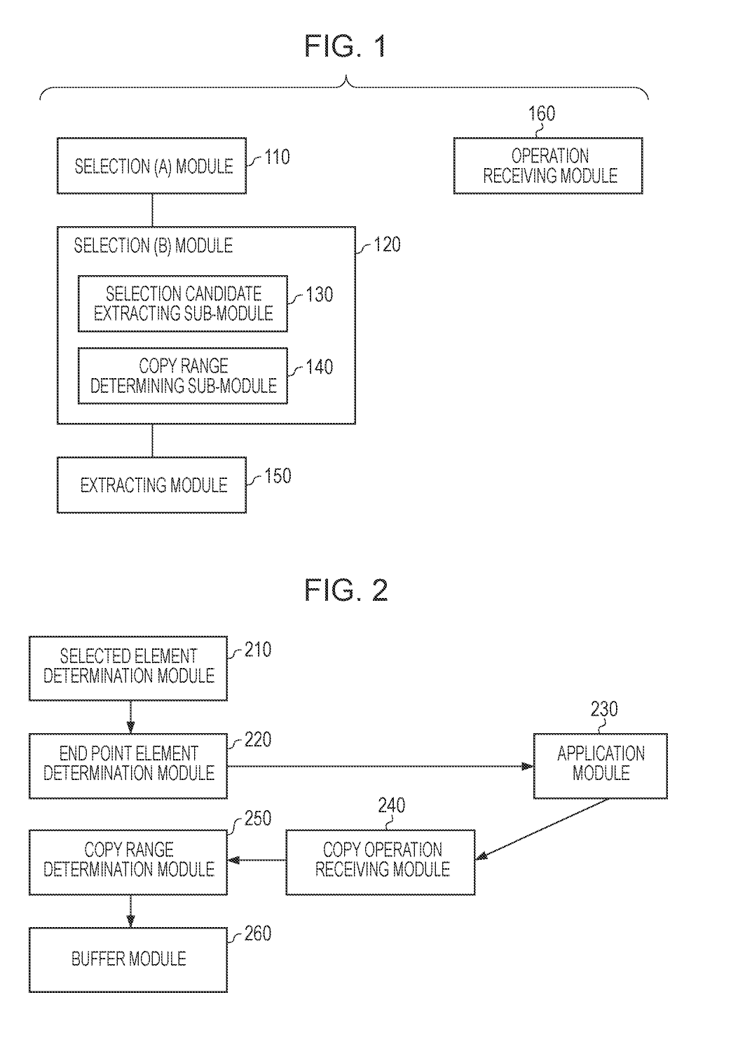

An exemplary embodiment of the present invention is described below with reference to the accompanying drawings. FIG. 1 is a module configuration diagram according to the present exemplary embodiment. As used herein, the term “module” refers to a component of software that is logically separated (as in a computer program) or a part of a hardware configuration. That is, according to the present exemplary embodiment, a module is not only a module of a computer program but a module of a hardware configuration. Therefore, the present exemplary embodiment also describes a computer program that functions as the module (a program for causing a computer to execute the procedure, a program for causing a computer to function as units, or a program for causing a computer to provide the functions), a system that functions as the module, and a method that functions as the module. Although, for convenience of description, the words “store” and “instruct to store” and variations thereof are used in the following description, these words mean “store data in a storage unit” and “perform control to store data in a storage unit”, respectively, if the exemplary embodiment is related to a computer program. In addition, there may be one-to-one correspondence between a module and a function. However, in an implementation, a module may be formed from a single program, or plural modules may be formed from a single program. Conversely, a module may be formed from plural programs. Furthermore, plural modules may be executed by a single computer, or a single module may be executed by plural computers in a distributed processing manner or a parallel processing manner. Note that a module may include another module. Still furthermore, as used herein, the term “connection” refers to a physical connection or a logical connection (e.g., exchange of data, instruction, and reference relationship between data items). The term “predetermined” refers to having determined prior to the time of start of a target process. Therefore, the term “predetermined” refers to not only having determined prior to the time of start of the processing according to the present exemplary embodiment but having determined prior to the time of start of a target process even after the time of start of the processing according to the present exemplary embodiment in accordance with the status or condition at the determined time or prior to that time. A system or an apparatus, herein, is formed from plural computers, plural hardware components, and plural devices connected to one another (including a peer-to-peer connection) using a communication medium, such as a network. Alternatively, a system or an apparatus may be formed from a single computer, a single hardware component, or a single device. The terms “apparatus” and “system” may be used interchangeably. Note that the term “system” does not include human-made “patterned social arrangements” in society (a social system). In addition, each time a process is performed by each of the modules or each time plural processes are performed within a module, information to be processed is read from a storage unit for each of the processes. Thereafter, the information is processed, and the result of the process is written into the storage unit. Accordingly, reading of information from a storage unit before the process is performed and writing of the result of the process into the storage unit after the process has been performed are not always described. Note that examples of the storage unit include a hard disk, a random access memory (RAM), an external storage medium, a storage unit connected via a communication line, and a register in a central processing unit (CPU).

An exemplary embodiment is described below with reference to a structured document serving as tree-structured data. According to the present exemplary embodiment, an information processing apparatus extracts data of a subtree from the tree-structured data in order to copy the data of the subtree into other tree-structured data. As indicated by an example illustrated in FIG. 1, the information processing apparatus includes a selection (A) module 110, a selection (B) module 120, an extracting module 150, and an operation receiving module 160. The selection (B) module 120 includes a selection candidate extracting sub-module 130, and a copy range determining sub-module 140.

The selection (A) module 110 is connected to the selection (B) module 120. The selection (A) module 110 selects a first element in tree-structured data. The term “tree structure” refers to a data structure including an information item in the form of node data representing a node in the tree-structured data. A node other than a root node has a parent node. The tree structure has only one root node. An example of the tree-structured data is the data of a tree-structured document. The first element represents a node of the tree-structured data and is a node serving as a terminal point of a subtree (a “root node” or a “leaf node”) that is selected through an operation performed by an operator and that is to be copied. If the first element serves as a leaf node of the subtree, the number of the first elements may be plural. However, since the subtree to be copied is one, the number of the first elements is one if the first element serves as the root node of the subtree. The first element serves as a node at which the selection operation performed by the operator begins.

The selection (B) module 120 is connected to the selection (A) module 110 and the extracting module 150. The selection (B) module 120 selects a second element corresponding to the first element selected by the selection (A) module 110. The term “second element” refers to a node that constitutes the tree-structured data including the first element and that serves as a terminal point of the subtree selected to be copied through the operation performed by the operator (i.e., the root node or a leaf node). If the first element is the root node of the subtree, the second element is a leaf node of the subtree. However, if the first element is a leaf node of the subtree, the second element is the root node of the subtree. Note that if the second element is a leaf node of the subtree, the number of the second elements may be plural. However, if the second element is the root node of the subtree, the number of the second elements is one since the number of the subtrees to be copied is one. The second element serves as a node at which the operation performed by the operator ends (an end point).

The selection candidate extracting sub-module 130 extracts a candidate for the second element corresponding to the first element selected by the selection (A) module 110. If plural candidates for the second element are extracted, the copy range determining sub-module 140 selects one of the second elements on the basis of an operation performed by the operator. Through such selection, the tree-structured data for a copy range can be determined. For example, plural candidates for the second element are displayed on a display unit, and the operator selects one of the displayed candidates for the second element.

If the selection candidate extracting sub-module 130 extracts only one second element, it is not necessary for the operator to select one of the second elements. Accordingly, the second element is selected without the operation for selecting the first element performed by the operator. However, even in such a case, the second element may be selected by the operator for a purpose of confirmation as in the case in which plural candidates of the second element are present. Alternatively, the second element may be displayed (or the subtree may be displayed), and the operator may confirm that the node is selected as the second element. For example, if a leaf node of the subtree is selected as the first element, only the root node may be the candidate of the second element. That is, at that time, the first element is a node immediately below the root node of the entire tree structure, or the first element is the root node of the entire tree structure. Alternatively, if the root node of the subtree is selected as the first element, only a leaf node of the entire tree structure may be the candidate of the second element. That is, at that time, the first element is a node immediately above a leaf node of the entire tree structure, or the first element is a leaf node of the entire tree structure.

The first element selected by the selection (A) module 110 is an element in the lower layer of the tree-structured data extracted by the extracting module 150. In contrast, the second element selected by the selection (B) module 120 is an element in the upper layer of the tree-structured data extracted by the extracting module 150. That is, the first element serves as a leaf node of the subtree, and the second element serves as the root node of the subtree.

If plural first elements are selected by the selection (A) module 110, the selection candidate extracting sub-module 130 extracts, from among the candidates of the second element corresponding to the plural first elements, the duplicated element as the candidate of the second element. As used herein, if the number of the first elements is two, the term “duplicated element” refers to an element that corresponds to one of the first elements and also corresponds to the other first element. If the number of the first elements is three or more, the term “duplicated element” refers to an element that corresponds to all of the three or more first elements.

The selection candidate extracting sub-module 130 determines whether one of the first elements (hereinafter referred to as a “first element A) is located in an upper layer of the other first element (hereinafter referred to as a “first element B). If the first element A is located in an upper layer of the first element B, the selection candidate extracting sub-module 130 does not regard the first element A as a first element and extracts a candidate of the second element. As used herein, the case in which first element A is located in an upper layer of the first element B refers to the case in which when the tree is traversed from the first element B in a direction extending towards the upper layer and if a branch occurs, the first element A is reached without temporarily traversing the tree towards the lower layer. That is, the tree can be traversed from the first element B to the first element A in a straight line. In addition, the first element A does not serve as a leaf node of the subtree. Conversely, even when the first element A is located in the upper layer of the first element B, such a case is not included in the case in which first element A is located in an upper layer of the first element B if the two first elements serve as leaf nodes. That is, when the tree is traversed from the first element B in a direction extending towards the upper layer and if a branch appear, the three is temporarily traversed towards the lower layer (towards a leaf node) and the first element A is reached without returning to the node of the branch that has already been passed. Such a case is not included in the case in which first element A is located in an upper layer of the first element B.

The extracting module 150 is connected to the selection (B) module 120. The extracting module 150 extracts the tree-structured data representing the subtree defined by the first element selected by the selection (A) module 110 and the second element selected by the selection (B) module 120 in order to copy the tree-structured data into different tree-structured data. As used herein, the term “subtree” refers to part of the tree structure to be copied. In addition, a subtree represents the tree-structured data to be copied. A subtree is defined by a first element and a second element. That is, a subtree is defined by the root node and a leaf node. The number of the leaf nodes may be plural.

According to the present exemplary embodiment, the operation receiving module 160 of the information processing apparatus receives an operation performed by the operator. Thereafter, the operation receiving module 160 delivers the information regarding the operation to the selection (A) module 110 and the selection (B) module 120. Examples of the operation received by the operation receiving module 160 include at least an operation for selecting an element and an operation for copying data. For example, the operation may be an operation in which a copy instruction is received and, thereafter, a first element and a second element are selected from the tree-structured data. Alternatively, the operation may be an operation in which a first element and a second element are selected from the tree-structured data and, thereafter, a copy instruction is received. In addition, if plural second elements are present, a receiving operation performed by the operation receiving module 160 may be an operation for selecting one of the second elements. More specifically, the operation receiving module 160 receives an operation performed by an operator on, for example, a mouse, a keyboard, or a touch panel.

FIG. 2 is a module configuration diagram illustrating an exemplary configuration according to the present exemplary embodiment. The exemplary configuration includes a selected element determination module 210, an end point element determination module 220, an application module 230, a copy operation receiving module 240, a copy range determination module 250, and a buffer module 260. For example, a start point (a start element) and an end point (an end element) in a structured document are specified for a copy operation, and the subtree defined by the start point and the end point (the subtree formed from elements located on a line extending from the start point to the end point) is extracted as a copy range. Note that the number of start points may be plural. In such a case, the subtree defined by each of the start points and the end point is to be copied.

The selected element determination module 210 is connected to the end point element determination module 220. The selected element determination module 210 determines which one of elements is currently selected by the operator in an application or a system. The selected element serves as an element at the start point. The end point element determination module 220 is connected to the selected element determination module 210 and the application module 230. The end point element determination module 220 determines, as a candidate of the end point element, an ancestor element of the selected element determined by the selected element determination module 210. Thereafter, the end point element determination module 220 sends information indicating the candidate of the end point element to the application module 230. If the selected element determination module 210 determines that plural elements are selected, the end point element determination module 220 determines, as a candidate of the end point element, a common element of the ancestor elements of the selected elements. The application module 230 is connected to the end point element determination module 220 and the copy operation receiving module 240. The application module 230 displays, on a display, the information regarding the candidates of the end point elements sent from the end point element determination module 220.

The copy operation receiving module 240 is connected to the application module 230 and the copy range determination module 250. The copy operation receiving module 240 receives a copy operation performed by the operator in the application or the system and requests the copy range determination module 250 to determine the copy range. At that time, the end point element has been determined through an operation performed by the operator. That is, the copy operation is performed by specifying the end point element. The copy range determination module 250 is connected to the copy operation receiving module 240 and the buffer module 260. The copy range determination module 250 generates a subtree representing the copy range using the selected elements and the end point element. The buffer module 260 is connected to the copy range determination module 250. The buffer module 260 stores the subtree generated by the copy range determination module 250 as the information to be copied.

Almost entirety of the selected element determination module 210 corresponds to the selection (A) module 110 illustrated in FIG. 1. Almost entirety of the end point element determination module 220 corresponds to the selection candidate extracting sub-module 130 illustrated in FIG. 1. Almost entirety of the application module 230 and the copy operation receiving module 240 corresponds to the operation receiving module 160 illustrated in FIG. 1. Almost entirety of the copy range determination module 250 corresponds to the copy range determining sub-module 140 and the extracting module 150 illustrated in FIG. 1. In addition, the buffer module 260 stores the subtree extracted by the extracting module 150 illustrated in FIG. 1.

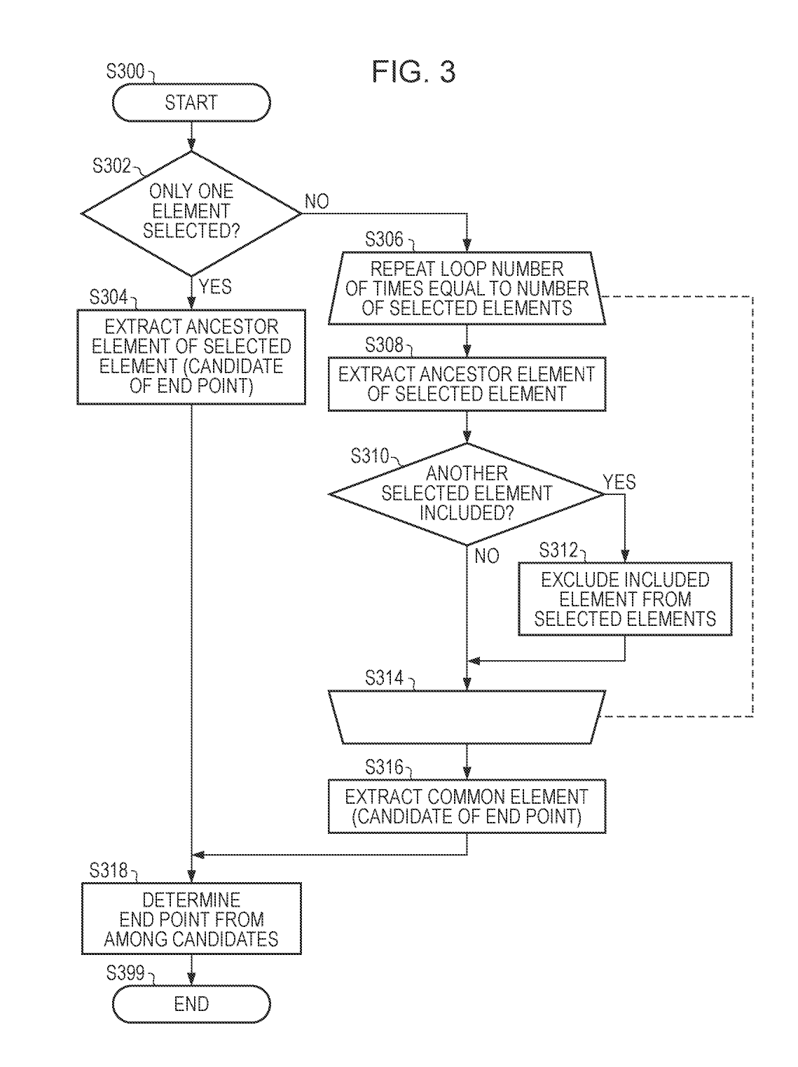

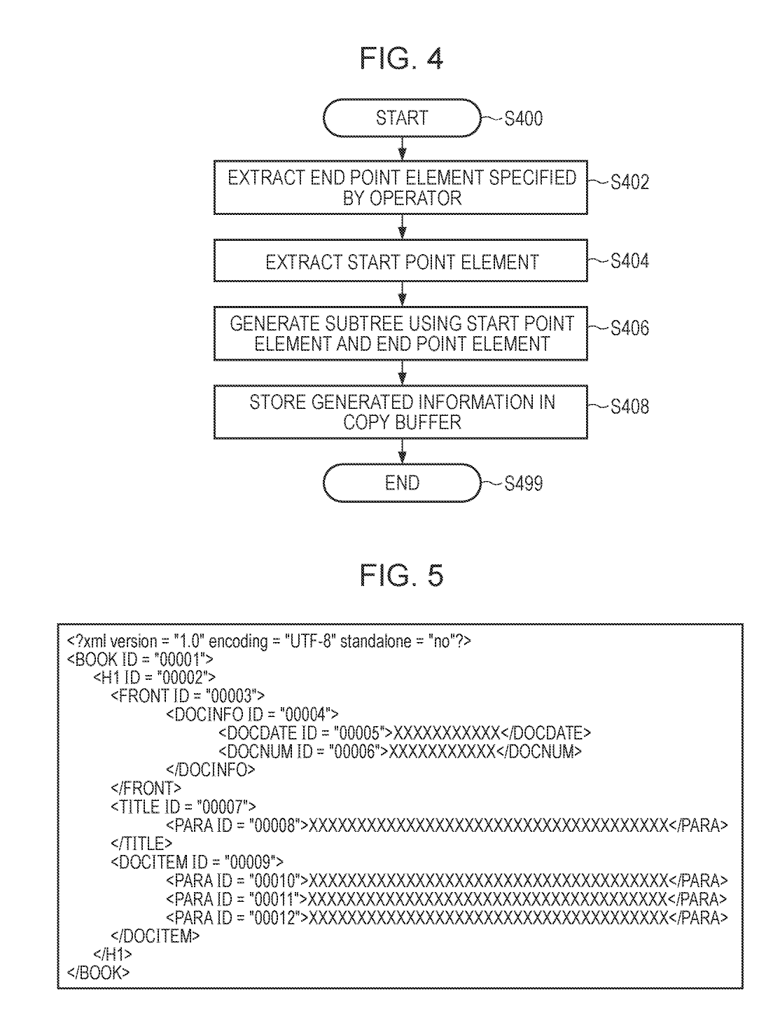

A flowchart illustrating the steps up to the determination of the end point and a flowchart illustrating the subsequent steps for determining the copy range using the end point element specified by the operator are described below. FIG. 3 is a flowchart illustrating the steps up to the determination of the end point. FIG. 4 is a flowchart illustrating the subsequent steps for determining the copy range using the specified end point. Note that the flowcharts are based on the case in which the start point is located in the lower layer (at a leaf node of a subtree) and the end point is located in the upper layer (the root node of the subtree). However, in the case opposite the above-described case, that is, in the case in which the start point is located in the upper layer (at the root node of a subtree) and the end point is located in the lower level (at a leaf node of a subtree), the flowcharts can be applied by replacing the word “upper” with the word “lower”. Note that at that time, if a branch appears, the operation “extracting a descendant element” can be performed by storing the branch in a stack and extracting the descendant element.

FIG. 3 is a flowchart of an exemplary process according to the present exemplary embodiment. In step S302, the selection candidate extracting sub-module 130 determines whether only one element is selected. If only one element is selected, the processing proceeds to step S304. Otherwise, the processing proceeds to step S306. In step S304, the selection candidate extracting sub-module 130 extracts an ancestor element of the selected element as a candidate of an end point. In step S306, the selection candidate extracting sub-module 130 performs the processes up to step S314 a number of times equal to the number of the selected elements. In step S308, the selection candidate extracting sub-module 130 extracts the ancestor element of the selected element. At that time, the ancestor element represents a node traversed in the upper level direction (the direction extending towards the root node) without being traversed in the lower level direction.

In step S310, the selection candidate extracting sub-module 130 determines whether another selected element is included. If another selected element is included, the processing proceeds to step S312. Otherwise, the processing proceeds to step S314. That is, if an element selected by the selection (A) module 110 is included in the extracted ancestor elements (i.e., if the selected element does not represent a leaf node in the subtree defining the copy range), the processing proceeds to step S312. In step S312, the selection candidate extracting sub-module 130 excludes the included element from the selected elements. Accordingly, if, in step S308, the ancestor element has already been extracted, the selection candidate extracting sub-module 130 excludes the extracted ancestor element. However, if, in step S308, the ancestor element has not yet been extracted, the ancestor element of the excluded element is not extracted afterward. Accordingly, the number of repetitions of the loop in step S306 is decreased by one. In step S316, the selection candidate extracting sub-module 130 extracts the common element as a candidate of the end point. Since plural elements are selected and, in step S308, the ancestor elements of the selected elements are extracted, the common element of the ancestor elements (i.e., a logical AND) is extracted. In step S318, the copy range determining sub-module 140 determines the end point from among the candidates. Through an operation performed by the operator, the end point is selected from among the plural candidates of the end point.

FIG. 4 is a flowchart of an exemplary operation according to the present exemplary embodiment (an exemplary operation performed by the extracting module 150). In step S402, the end point element specified by the operator is extracted. In step S404, a start point element is extracted. In step S406, a subtree is generated using the start point element and the end point element. In step S408, the generated information is stored in the copy buffer.

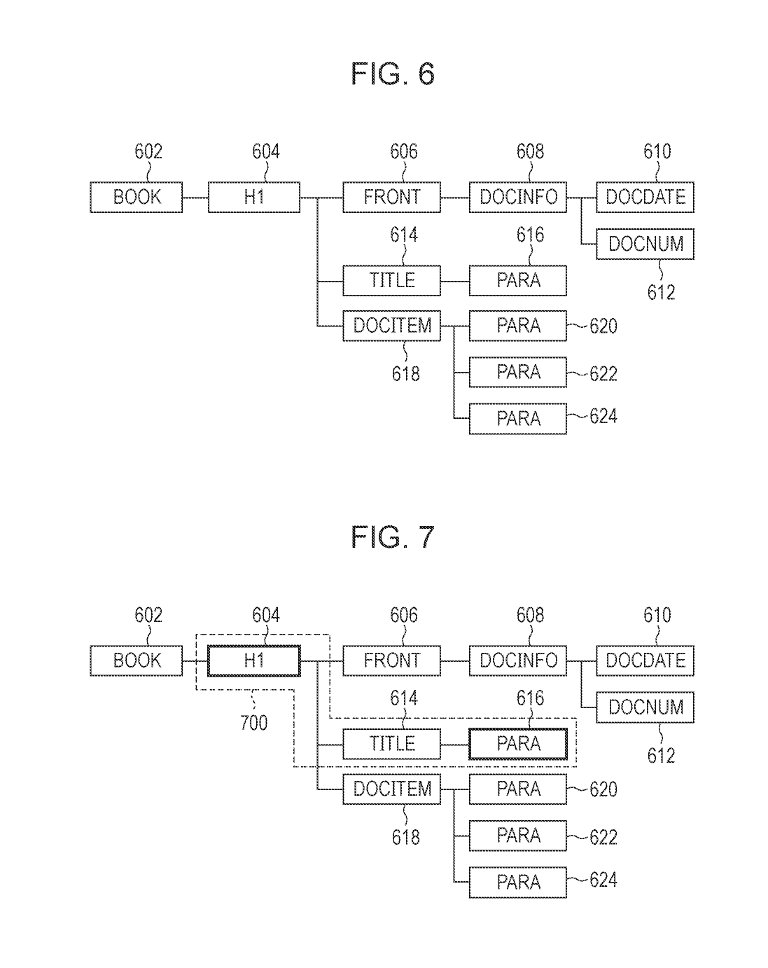

FIG. 5 illustrates an example of a structured document. FIG. 6 illustrates an example of displayed tree structure of the structured document illustrated in FIG. 5. In this example, an element is selected from the structured document, and a copy range is determined. The selected element serves as the start point of the copy range. An end point element is specified from among the ancestor elements of the selected element. The subtree defined by the start point and the end point serves as the copy range. Note that the tree structure illustrated in FIG. 6 is displayed on a display unit, and an operation performed on one of the nodes (e.g., a selecting operation) is received by the operation receiving module 160. A BOOK element 602 is the root node of the entire tree structure. An H1 element 604 is located as a sub-node of the BOOK element 602. A FRONT element 606, a TITLE element 614, and a DOCITEM element 618 are located as sub-nodes of the H1 element 604. A DOCINFO element 608 is located as a sub-node of the FRONT element 606. A DOCDATE element 610 and a DOCNUM element 612 are located as sub-nodes of the DOCINFO element 608. A PARA element 616 is located as a sub-node of the TITLE element 614. A PARA element 620, a PARA element 622, and a PARA element 624 are located as sub-nodes of the DOCITEM element 618.

The following three cases are describe below: the case where one start point and one end point are present, the case where one start point and two end points are present, and the case where two start points and one end point are present and another end point is present in a subtree defined by the start point and the end point. FIG. 7 illustrates an example of a start point element and an end point element selected in the tree structure of a structured document (the case where one start point and one end point are present). The PARA element 616 serves as the start point, and the H1 element 604 serves the end point. In this case, the subtree defined between the PARA element 616 and the H1 element 604 serves as a copy range 700. That is, the copy range 700 includes the H1 element 604, the TITLE element 614, and the PARA element 616. In addition, the candidates of the end point include the ancestor elements of the start point (the PARA element 616) (i.e., the TITLE element 614, the H1 element 604, and the BOOK element 602 in the example illustrated in FIG. 7). The end point is determined from among the candidates.

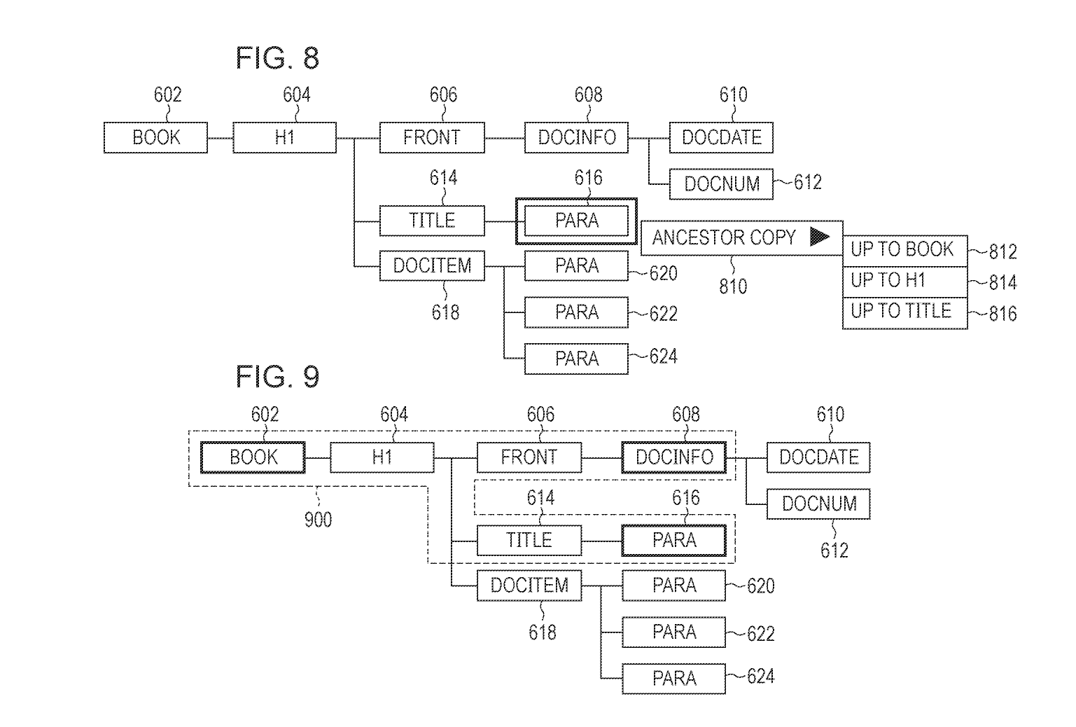

FIG. 8 illustrates an example of a user interface for selecting the end point. As in the example illustrated in FIG. 6, a structured document is displayed in the form of a tree view (this also applies to the following examples). In this case, a start point element (the PARA element 616) is selected through an operation performed by the operator, and an “ancestor copy” menu 810 is displayed. If the “ancestor copy” menu 810 is selected through the operation performed by the operator, three options 812, 814, and 816 indicating the candidates of the end point are displayed. In this example, the option 814 is selected as the end point element through the operation performed by the operator. Through such an operation, the copy range 700 represented by the subtree illustrated in FIG. 7 is determined. In the flowchart illustrated in FIG. 3, this example indicates the case in which the process of “Yes” in step S302 is performed.

FIG. 9 illustrates an example of a start point element and an end point element selected in the tree structure of a structured document (the case where one start point and two end points are present). In this case, the DOCINFO element 608 and the PARA element 616 serve as the start points, and the BOOK element 602 serves as the end point. In addition, the subtree defined between the DOCINFO element 608 and the BOOK element 602 and between the PARA element 616 and the BOOK element 602 is defined as a copy range 900. That is, the copy range 900 includes the BOOK element 602, the H1 element 604, the FRONT element 606, the DOCINFO element 608, the TITLE element 614, and the PARA element 616. Furthermore, common elements of the ancestor elements of each of the start point elements (the PARA element 616 and the DOCINFO element 608) (i.e., the H1 element 604 and the BOOK element 602 in the example illustrated in FIG. 9) serve as the candidates of the end point. The end point is determined from among the candidates.

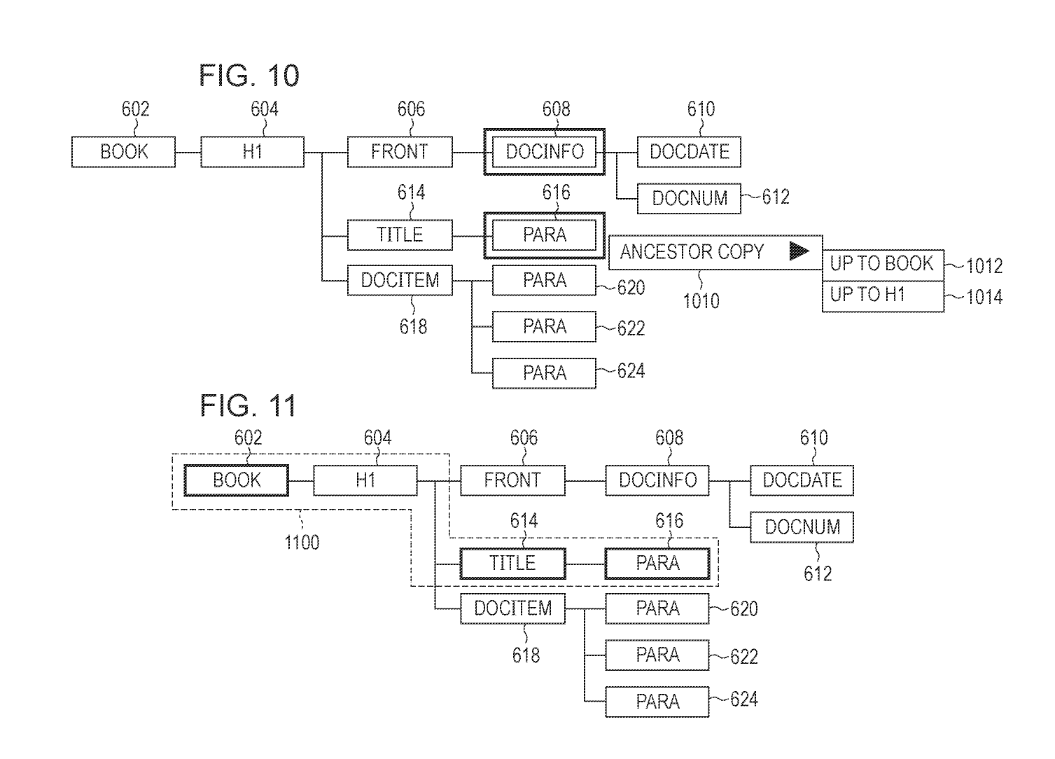

FIG. 10 illustrates an example of a user interface for selecting the end point. In this case, start point elements (the PARA element 616 and the DOCINFO element 608) are selected through an operation performed by the operator, and an “ancestor copy” menu 1010 is displayed. If the “ancestor copy” menu 1010 is selected through the operation performed by the operator, two options 1012 and 1014 indicating the candidates of the end point are displayed. In this example, the option 1012 is selected as the end point element through the operation performed by the operator. Through such an operation, the copy range 900 represented by the subtree illustrated in FIG. 9 is determined. In the flowchart illustrated in FIG. 3, this example indicates the case in which the process for “No” in step S302 is performed and the process for “No” in step S310 is performed.

FIG. 11 illustrates an example of a start point element and an end point element selected in the tree structure of a structured document (the case where two start points and one end point are present and another end point is present in a subtree defined by the start point and the end point). In this case, the TITLE element 614 and the PARA element 616 serve as the start points, and the BOOK element 602 serves as the end point. In this example, since the TITLE element 614 is located inside of a subtree formed from the PARA element 616 and the BOOK element 602, the TITLE element 614 is excluded from a group of the start points. Accordingly, in this case, the subtree defined between the PARA element 616 and the BOOK element 602 serves as a copy range 1100. That is, the copy range 1100 includes the BOOK element 602, the H1 element 604, the TITLE element 614, and the PARA element 616. In addition, the ancestor elements of the start point element (the PARA element 616) (i.e., the TITLE element 614, the H1 element 604, and the BOOK element 602 in the example illustrated in FIG. 11) are selected as the candidates of the end point. The end point is determined from among the candidates. Note that this process is performed after the TITLE element 614 is selected as the start point by mistake.

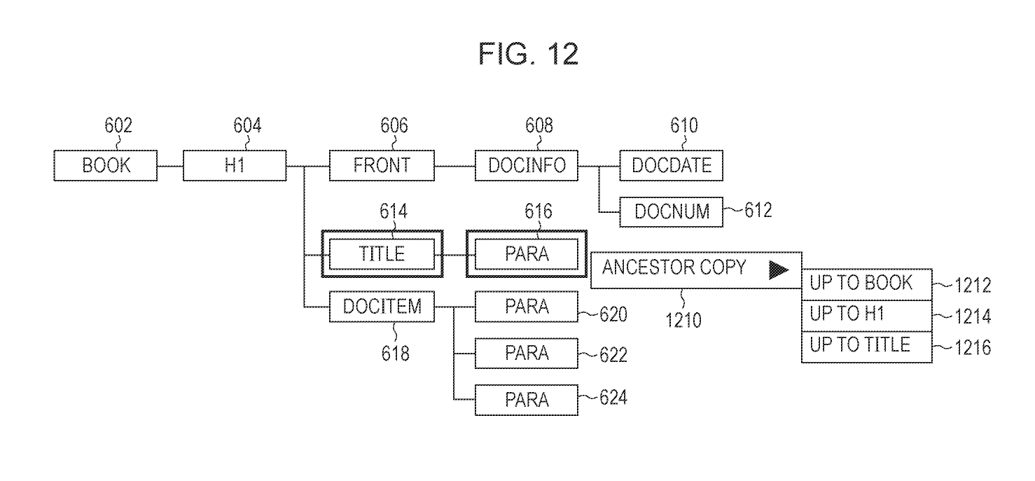

FIG. 12 illustrates an example of a user interface for selecting the end point. In this case, start point elements (the PARA element 616 and the TITLE element 614) are selected, and an “ancestor copy” menu 1210 is displayed. If the “ancestor copy” menu 1210 is selected through the operation performed by the operator, three options 1212, 1214, and 1216 indicating the candidates of the end point are displayed. In this example, the option 1212 is selected as the end point element through the operation performed by the operator. Through such an operation, the copy range 1100 represented by the subtree illustrated in FIG. 11 is determined. In the flowchart illustrated in FIG. 3, this example indicates the case in which the process for “No” in step S302 is performed and the process for “Yes” in step S310 is performed.

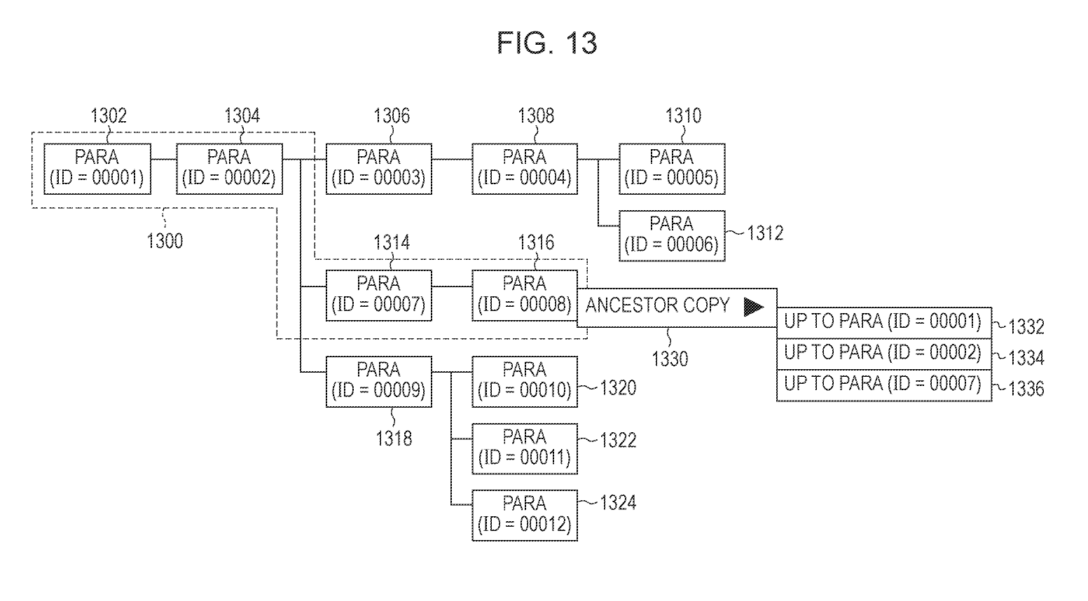

FIG. 13 illustrates a displayed structured document including elements having the same name. When plural candidates of the end point having the same name are present and if the element names described in the above example are displayed as the candidates of the end point, it is difficult for the operator to distinguish from one another. In such a case, the elements can be displayed using the attributes of the elements. In the example illustrated in FIG. 13, the elements have the same element name “PARA”. However, the ID attributes are used for distinguishing the elements from one another. In this case, a start point element (a PARA element (ID=00008) 1316) is selected through the operation performed by the operator, and an “ancestor copy” menu 1330 is displayed. If the “ancestor copy” menu 1330 is selected through the operation performed by the operator, three options 1332, 1334, and 1336 indicating the candidates of the end point element are displayed using the element names and their attributes. Thereafter, the option 1332 is selected as the end point element through the operation performed by the operator. Through such an operation, the subtree illustrated in FIG. 13 is determined as a copy range 1300. That is, the copy range 1300 includes the PARA element (ID=00001) 1302, the PARA element (ID=00002) 1304, the PARA element (ID=00007) 1314, and the PARA element (ID=00008) 1316. Note that the elements displayed in the form of a tree view are also represented using the element names and their attributes.

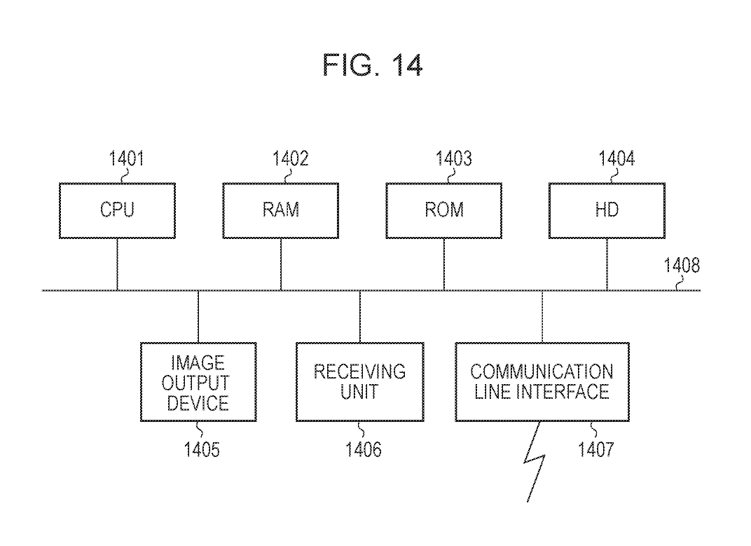

As illustrated in FIG. 14, the hardware configuration of a computer that executes the program according to the present exemplary embodiment is the same as that of a widely used computer. More specifically, a personal computer or a server can be used as the computer. That is, for example, a CPU 1401 is used as the processing unit (a computing unit). In addition, a RAM 1402, a ROM 1403, and an HD 1404 are used as the storage unit. An example of the HD 1404 is a hard disk. The CPU 1401 executes the programs functioning as the selection (A) module 110, the selection (B) module 120, the selection candidate extracting sub-module 130, the copy range determining sub-module 140, the extracting module 150, the operation receiving module 160, the selected element determination module 210, the end point element determination module 220, the application module 230, the copy operation receiving module 240, and the copy range determination module 250. The RAM 1402 stores these programs and data. The ROM 1403 stores, for example, a program for starting the computer. The HD 1404 serves as an auxiliary storage unit. A receiving unit 1406 receives data on the basis of the operation performed on a keyboard, a mouse, or a touch panel by the operator. An image output device 1405, such as a cathode-ray tube (CRT) or a liquid crystal display, outputs data. A communication line interface 1407, such as a network interface card, connects the computer to a communication network. A bus 1408 connects the devices to one another so that these devices communicate data with one another. Such computers may be connected to one another via a network.

In the above-described embodiment based on a computer program, a computer program, which is software, is read by the system having the above-described hardware configuration. Thereafter, the above-described embodiment is realized by the software and the hardware resources that work in a cooperative manner. Note that the hardware configuration illustrated in FIG. 14 is only an example. The hardware configuration according to the present exemplary embodiment is not limited to the hardware configuration illustrated in FIG. 14. Any hardware configuration that executes the modules of the present exemplary embodiment can be employed. For example, some of the modules may be formed from dedicated hardware (e.g., an application specific integrated circuit (ASIC)). Some of the modules may be disposed in an external system and may be connected using a communication line. Alternatively, plural systems each having the configuration illustrated in FIG. 14 may be connected to one another using a communication line and work in a cooperative manner. Still furthermore, the modules may be integrated into a home information appliance, a copier, a FAX, a scanner, a printer, or a multifunction peripheral (an image processing apparatus having at least two of the functions of a scanner, a printer, a copier, and a FAX) instead of a personal computer. Note that each of the modules may perform the processes thereof using a technique described in the related art.

The above-described programs may be stored in a storage medium and be distributed. Alternatively, the programs may be distributed using a communication medium. In such a case, for example, the invention of the above-described programs may be considered as the invention of a “computer readable medium storing the program”. The term “computer readable medium storing the program” refers to a computer-readable storage medium that stores the program and that is used for installing the program, executing the program, and distributing the program. Examples of the storage medium include a digital versatile disc (DVD), a compact disc (CD), a Blu-ray® disc, a magnetooptical disk (an MO), a flexible disk (FD), a magnetic tape, a hard disk, a read only memory (ROM), an electrically erasable programmable read-only memory (EEPROM®), a flash memory, and a random access memory (RAM). Examples of the DVD include a DVD Recordable (DVD-R), a DVD Rewritable (DVD-RW), and a DVD random access memory (DVD-RAM) defined by the DVD forum and a DVD+R and a DVD+RW defined by the DVD+RW Alliance. Examples of the CD include a compact disc read only memory (CD-ROM), a CD recordable (CD-R), and a CD rewritable (CD-RW). All or some of the programs may be stored in the storage medium and be distributed. Alternatively, all or some of the programs may be transmitted using a transmission medium (e.g., a wired or wireless network, such as a local area network (LAN), a metropolitan area network (MAN), a wide area network (WAN), the Internet, an extranet, and any combinations thereof). Still alternatively, all or some of the programs may be transmitted using a carrier wave. In addition, the above-described programs may be part of another program. Alternatively, the programs may be stored in a storage medium together with another program. The programs may be stored in different storage media. In addition, the programs may be stored in any compression or encryption format that can be recovered into the original format.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first selection unit that selects at least one first element in tree-structured data;
a second selection unit that selects a second element corresponding to the first element selected by the first selection unit; and
an extracting unit that extracts tree-structured data representing a subtree defined by the first element selected by the first selection unit and the second element selected by the second selection unit in order to copy the tree-structured data into different tree-structured data.

2. The information processing apparatus according to claim 1, wherein the second selection unit extracts at least one candidate of the second element corresponding to the first element selected by the first selection unit from the tree-structured data, and wherein if a plurality of the candidates of the second element are extracted, the second selection unit selects the second element on the basis of an operation performed by an operator.

3. The information processing apparatus according to claim 1, wherein the first element selected by the first selection unit is an element in a lower layer of the tree-structured data extracted by the extracting unit, and wherein the second element selected by the second selection unit is an element in an upper layer of the tree-structured data extracted by the extracting unit.

4. The information processing apparatus according to claim 2, wherein if a plurality of the first elements are selected by the first selection unit, the second selection unit extracts, as a candidate of the start point, a duplicated element from among the candidates of the second element corresponding to the first elements.

5. The information processing apparatus according to claim 4, wherein the second selection unit determines whether one of the first elements is an ancestor of the other first element among the plurality of the first elements, and if the one of the first elements is an ancestor of the other first element, the second selection unit does not regard the one of the first elements as a first element and extracts the candidate of the second element.

6. A non-transitory computer readable medium storing a program causing a computer to execute a process for processing information, the process comprising:
selecting at least one first element in tree-structured data;
selecting a second element corresponding to the selected first element; and
extracting tree-structured data representing a subtree defined by the selected first element and the selected second element in order to copy the tree-structured data into different tree-structured data.

7. An image processing method comprising:
selecting at least one first element in tree-structured data;
selecting a second element corresponding to the selected first element; and
extracting tree-structured data representing a subtree defined by the selected first element and the selected second element in order to copy the tree-structured data into different tree-structured data.
